(19) United States
(12) Patent Application Publication
(10) Pub. No.: US 2026/0368832 A1
(43) Pub. Date: Nov. 19, 2026

(54) REAL-TIME RECEIPT VERIFICATION AND COMPLIANCE NOTIFICATION SYSTEM FOR EXPENSE REPORTING

(71) Applicant: Emburse, Inc., Dallas, TX (US)

(72) Inventors: Ken Ringdahl, Salem, NH (US); Paul Nagy, Dallas, TX (US); Adriana Carpenter, Dallas, TX (US); John Brusk, Dallas, TX (US); Marcus Seuser, Dallas, TX (US); Wesley Bassler, Dallas, TX (US); Sam Mekhdi, Dallas, TX (US); Jess Goldberg, Dallas, TX (US)

(21) Appl. No.: 19/681,270

(22) Filed: May 19, 2026

Related U.S. Application Data
(60) Provisional application No. 63/808,121, filed on May 19, 2025.

(51) Int. Cl. G06Q 40/12; G06V 30/413

(52) U.S. Cl. CPC G06Q 40/124; G06V 30/413

(57) ABSTRACT

A system is provided. The system includes at least one processor programmed to: a) receive an image of a document to be analyzed; b) extract a plurality of data from the image of the document; c) execute a classification model trained to identify a document type based on the plurality of data, where the classification model outputs a document type for the document; d) determine an analysis model of a plurality of analysis models to execute based on the document type; e) execute the determined analysis model for the document type, wherein the analysis model has been trained to validate the plurality of data from the document in view of a plurality of policies; f) detect a compliance issue with the document based on the execution of the determined analysis model; and g) provide real-time feedback on the document based on the detected compliance issue with the document.

### CROSS REFERENCE TO RELATED APPLICATIONS

This application claims priority to U.S. Provisional Application No. 63/808,121, filed May 19, 2025, the contents of which are incorporated herein by reference in its entirety.

### BACKGROUND

The field of the invention relates generally to using artificial intelligence for real-time receipt verification and compliance notification, and more specifically to systems and methods to execute multiple artificial intelligence models for cloud-based real-time analysis and verification of receipts and invoices to ensure compliance with organization-specific rulesets and regulatory compliance.

In many cases, users fail to capture complete and compliant receipts at the point of purchase. This happens particularly in situations, like dining, where itemized and summary receipts are provided separately. If incomplete data is collected and the user leaves the site, the missing information may become irretrievable. This can lead to compliance risks, manual overhead, and potential monetary impact (e.g., lost VAT (Value-added tax) reclaim). In the case of a multi-national company, reclaiming automatically charged taxes, such as VAT, is possible. However, if an end user does not obtain a proper tax invoice or documentation, the reclaim of the taxes paid may either be impossible or not pass an audit. The latter of which could lead to fines if tax reclaim is attempted without the proper documentation. This could expose an officer, such as a CFO (chief financial officer), to personal penalties and liabilities.

Additionally, every organization has their own unique expense policies which an expense user may be unaware of. A purchase that is not eligible for reimbursement per policy could be made by the end user. Notifying that user immediately at the point of sale could allow them to void the transaction that they might otherwise be personally responsible for. Furthermore, notifying the user of potential errors at the point of sale would be helpful as well. Many times for large parties at restaurants, a tip is automatically applied. A user might accidentally add a tip to the bill, not recognizing that one was already applied.

Accordingly, it would be desirable to have a methodology of real-time expense analysis that provides the user with feedback in view of their organization’s policies and regulatory compliance.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system is provided. The system includes at least one computer device including at least one processor in communication with at least one memory device. The at least one processor is programmed to: a) receive an image of a document to be analyzed; b) extract a plurality of data from the image of the document; c) execute a classification model trained to identify a document type based on the plurality of data, where the classification model outputs a document type for the document; d) determine an analysis model of a plurality of analysis models to execute based on the document type; e) execute the determined analysis model for the document type, wherein the analysis model has been trained to validate the plurality of data from the document in view of a plurality of policies; f) detect a compliance issue with the document based on the execution of the determined analysis model; and g) provide real-time feedback on the document based on the detected compliance issue with the document. The system may have additional, less, or alternate functionalities, including those discussed elsewhere herein.

In another aspect, a computer device is provided. The computer device includes at least one processor (or “the processor”) in communication with at least one memory device. The processor is programmed to a) receive an image of a document to be analyzed; b) extract a plurality of data from the image of the document; c) execute a classification model trained to identify a document type based on the plurality of data, where the classification model outputs a document type for the document; d) determine an analysis model of a plurality of analysis models to execute based on the document type; e) execute the determined analysis model for the document type, wherein the analysis model has been trained to validate the plurality of data from the document in view of a plurality of policies; f) detect a compliance issue with the document based on the execution of the determined analysis model; and g) provide real-time feedback on the document based on the detected compliance issue with the document. The computer device may have additional, less, or alternate functionalities, including those discussed elsewhere herein.

In a further aspect, a computer implemented method is provided. The method implemented by at least one processor (or “the processor”) in communication with at least one memory device. The method includes a) receive an image of a document to be analyzed; b) extract a plurality of data from the image of the document; c) execute a classification model trained to identify a document type based on the plurality of data, where the classification model outputs a document type for the document; d) determine an analysis model of a plurality of analysis models to execute based on the document type; e) execute the determined analysis model for the document type, wherein the analysis model has been trained to validate the plurality of data from the document in view of a plurality of policies; f) detect a compliance issue with the document based on the execution of the determined analysis model; and g) provide real-time feedback on the document based on the detected compliance issue with the document. The method may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a system for real-time receipt verification and compliance notification, in accordance with at least one embodiment.

FIG. 2 illustrates a process using artificial intelligence for real-time receipt verification and compliance notification using the system shown in FIG. 1, in accordance with at least one embodiment.

FIG. 3 illustrates an exemplary process for using artificial intelligence for real-time receipt verification and compliance notification using the system shown in FIG. 1, in accordance with at least one embodiment.

FIGS. 4A-4E illustrate views of a user interface for real-time receipt verification and compliance notification using the system shown in FIG. 1.

FIG. 5 illustrates an exemplary computer system for real-time receipt verification and compliance notification, in accordance with at least one embodiment of the disclosure.

FIG. 6 depicts an artificial intelligence (AI)/deep learning (DL) module, according to an embodiment.

FIG. 7 depicts an exemplary configuration of user computer device, in accordance with one embodiment of the present disclosure.

FIG. 8 depicts an exemplary configuration of a server computer device, in accordance with one embodiment of the present disclosure.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present embodiments may relate to, inter alia, systems and methods for using artificial intelligence for real-time receipt verification and compliance notification, and more specifically to systems and methods to execute multiple artificial intelligence models for cloud-based real-time analysis and verification of receipts and invoices to ensure compliance with organization-specific rulesets and regulatory compliance. The systems and methods presented in this disclosure describe a real-time, context-aware system for validating transaction documentation and enforcing expense policy compliance at or near the point of transaction. The system integrates mobile capture, cloud-based document processing, contextual inference, cross-document reasoning and a configurable policy engine to determine whether a submitted document is the correct document type and semantically compliant, rather than merely complete based on the extraction of arbitrary values from of a set of targeted entities based on the context presented.

Upon capture of a document (e.g., a receipt or invoice), the system classifies the document type (e.g., receipt v. itinerary v. hotel folio, etc.). The system also classifies the expense type (e.g., meals, lodging, airfare, etc.). The system infers expected data elements and document structure based on contextual signals, including expense type, merchant category, and jurisdiction. In some embodiments, the system generates a semantic schema for the document based on contextual signals associated with the financial transaction. The expected semantic schema may define expected fields, relationships between fields, expected document structure, expected tax attributes, expected itemization requirements, and expected compliance indicators for the inferred transaction context. The system also extracts expected data elements based on the context that are observable on the document using a multi-modal large language model (LLM). Then the system validates both extracted and inferred data against organization-specific policies and regulatory requirements as well as other previously and concurrently loaded documents.

If inconsistencies, policy violations, or incorrect document types are detected, the system provides immediate feedback within a transaction-bound time window, enabling the user to remediate while still in the transaction context. This approach shifts compliance from post-processing to real-time, inference-driven validation and enforcement, improving accuracy, reducing audit risk, and enabling recovery of otherwise irretrievable documentation.

In the example embodiment, the system is configured to retrieve key data points from received documents. Examples of these data points include, but are not limited to, merchant, date, total amount, tax amount, items/itemization, document type, currency, and/or payment type. Some of these data points are directly extracted from the document, others are inferred based on context information. The system uses artificial intelligence models to perform assurance checks in one or more of the following categories: receipt validity, duplication, policy compliance, tax compliance, amount/price anomalies, tip anomalies, person expense, vendor legitimacy, time/location based, and/or document authenticity, for example.

Advantages of the system described herein include, but are not limited to, Inference-driven validation: determining expected data and document structure based on context, rather than detecting missing fields; document-type correctness evaluation: validation of whether the appropriate document (e.g., itemized vs. summary) has been captured; context-aware schema generation: dynamically defining expected data requirements based on expense type and jurisdiction; policy validation using inferred and extracted data: evaluating compliance using both observed and derived information; closed-loop, time-bound remediation: enabling corrective action within the active transaction context; and semantic consistency validation: ensuring logical alignment between values (e.g., totals, taxes, categories). In some embodiments, semantic consistency validation includes evaluating logical relationships between extracted and inferred values, including subtotal-to-tax relationships, gratuity consistency, transaction chronology consistency, merchant-category consistency, and jurisdiction-specific tax compliance relationships.

Many traditional systems that rely on post-submission validation; detect only missing or malformed fields; and/or apply static rules without contextual understanding. The systems and methods described herein introduce many improvements. First is the Contextual Inference Layer that allows the system to infer what data should exist, enabling validation even when fields are not explicitly present. Next is Document-Type Validation where the system determines whether the correct document type has been captured, not just whether a document is complete. Additionally, Semantic Compliance Evaluation supports assessing compliance based on relationships between data elements, not just field presence. Furthermore, Transaction-Bound Enforcement supports validation that occurs within a time- and context-constrained window, enabling real-world remediation. Moreover, the Dynamic Policy Application provides policies that are applied using both inferred and extracted data, enabling more accurate and flexible enforcement.

While the present disclosure describes receipt analysis and validation, one having ordinary skill in the art would understand that the present systems and methods could be used for other use cases, including, but not limited to, enterprise expense management and compliance; VAT/GST (Goods and Services Tax) tax reclaim optimization; travel and entertainment (T&E) expense validation; real-time financial compliance systems; and mobile-first finance and accounting platforms.

The multiple artificial intelligence model system described herein provides a significant improvement over other methodologies. By having multiple AI models each trained for different document types, this significantly reduces the amount of computing resources required for training and execution of these models. Furthermore, using a first model to identify the document type, allows for the efficient use of these models to allow them to work in real-time. In contrast to having a single large model that handles multiple document types, this requires significantly more computing resources to train, store, and execute. This separated system allows for efficient and streamlined use of these AI models. Furthermore, by having models trained for specific document types prevents the chance of AI confusion and hallucinations, greatly increasing the accuracy of the output of these models.

Conventional document processing systems utilize monolithic extraction and validation architectures requiring execution of generalized models across heterogeneous document types, resulting in increased computational overhead, increased memory utilization, reduced inference speed, and increased classification ambiguity. The disclosed system improves computer functionality by dynamically routing documents to specialized analysis models based on inferred document type and contextual metadata, thereby reducing computational resource consumption, improving inference latency, reducing hallucination frequency, improving semantic validation accuracy, and enabling transaction-bound remediation workflows not achievable using static validation architectures.

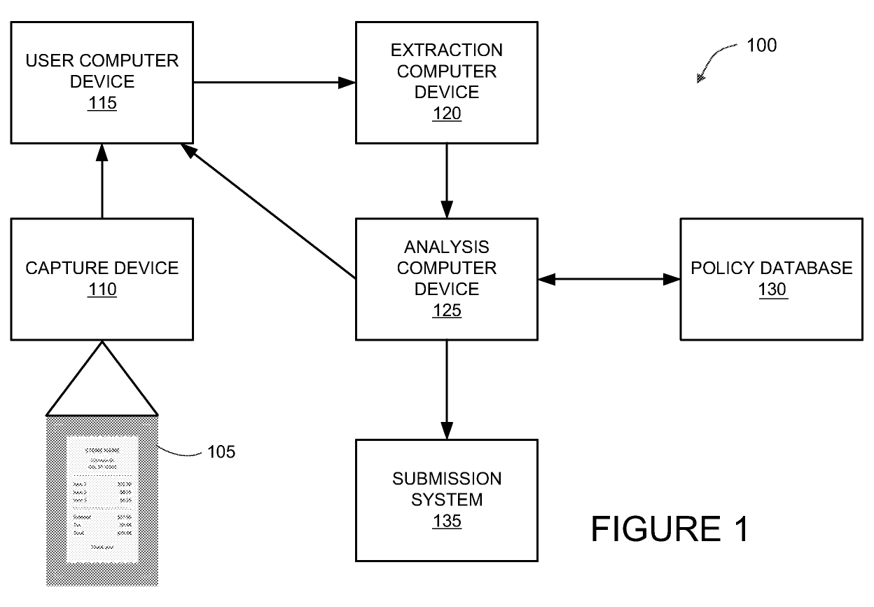

FIG. 1 illustrates a system 100 for real-time receipt verification and compliance notification, in accordance with at least one embodiment. The system 100 is configured to receive a document 105, such as a receipt or invoice. In the example embodiment, the document 105 is captured by a capture device 110. In some embodiments, the capture device 110 is a camera or a scanner capable of capturing an image of the document 105. In the example embodiment, the capture device 110 provides the image of the document 105 to a user computer device 115. In some embodiments, the user computer device 115 is a mobile device, such as, but not limited to a smartphone, where the smartphone includes the capture device 110, such as a digital camera.

In system 100, the user computer device 115 provides the image of the document 105 to an extraction computer device 120. The extraction computer device 120 is configured to extract data from the image of the document 105. For example, the extraction computer device 120 may execute OCR (optical character recognition) and/or natural language processing to retrieve/extract data from the image of the document 105. In some embodiments, the extraction computer device 120 also determines a type of the document based on the extracted data. The extraction computer device 120 may also infer one or more items of data from the extracted data. For example, the extraction computer device 120 that there were four guests at a dinner based on the number of entrees ordered and listed on the document 105.

The extraction computer device 120 provides the extracted data, the inferred data, and potentially the document type to an analysis computer device 125. The analysis computer device 125 is configured to analyze the extracted data and the inferred data to determine if there are any issues with the document 105 and the ability to submit the document 105 as an expense, such as for reimbursement. In the example embodiment, the analysis computer device 125 executes a plurality of trained artificial intelligence models to analyze the data and compare it to a plurality of policies and regulations to ensure that the data from the document 105 is in compliance. If there are any compliance issues, the analysis computer device 125 provides feedback to the user via the user computer device 115. This feedback may request that the user fills in one or more fields, and/or makes one or more clarifications or corrects to complete the document 105 for submission. Then the user computer device 115 submits the updated information. If there are no compliance issues, then the analysis computer device 125 may submit the extracted and inferred data to a submission system 135 to allow that data be submitted for reimbursement, etc.

In some embodiments, the analysis computer device 125 performs one or more additional compliance checks based on the one or more inferred items of data. For example, the analysis computer device 125 may infer a large number for the number of diners and then perform a check for the potential of a double tip.

A user captures a transaction document 105 using a mobile application on their user computer device 115. The document 105 is then transmitted to a cloud-based processing system, such as extraction computer device 120 and analysis computer device 125, in near real-time. In some embodiments, extraction computer device 120 and analysis computer device 125 are separate systems. In other embodiments, extraction computer device 120 and analysis computer device 125 are contained in the same system. The system 100 classifies the document type using structural and semantic analysis (e.g., distinguishing itemized receipts from summary receipts). In these embodiments, the system 100 determines an expected data schema based on a plurality of fields, including, but not limited to: document type; expense category (e.g., meals, lodging, transportation); merchant type; geographic or tax jurisdiction; and/or available transaction metadata.

The extraction computer device 120 performs OCR to extract textual and structural data elements. The extraction computer device 120 applies contextual inference to derive expected or implied data elements, including, but not limited to: tax structure and amounts; itemization requirements; logical relationships between subtotal, tax, and total; and/or required attributes for compliance within a jurisdiction. The analysis computer device 125 evaluates both extracted and inferred data against a configurable policy engine that includes: organization-specific expense policies; regulatory and tax requirements; and/or cross-field consistency rules. The analysis computer device 125 determines: whether the correct document type has been captured; whether the document is compliant with policy and regulatory expectations; and whether inconsistencies exist between inferred and extracted values.

Within a defined transaction-bound time window, the system 100 provides a notification to the user that includes: a compliance determination; an explanation of inconsistencies or violations; and/or recommended remediation actions (e.g., capture itemized receipt, request tax invoice, cancel transaction). The notification may be submitted to the user computer device 115.

The system 100 supports closed-loop interaction, allowing the user to submit revised documentation and re-evaluate compliance within the same transaction context.

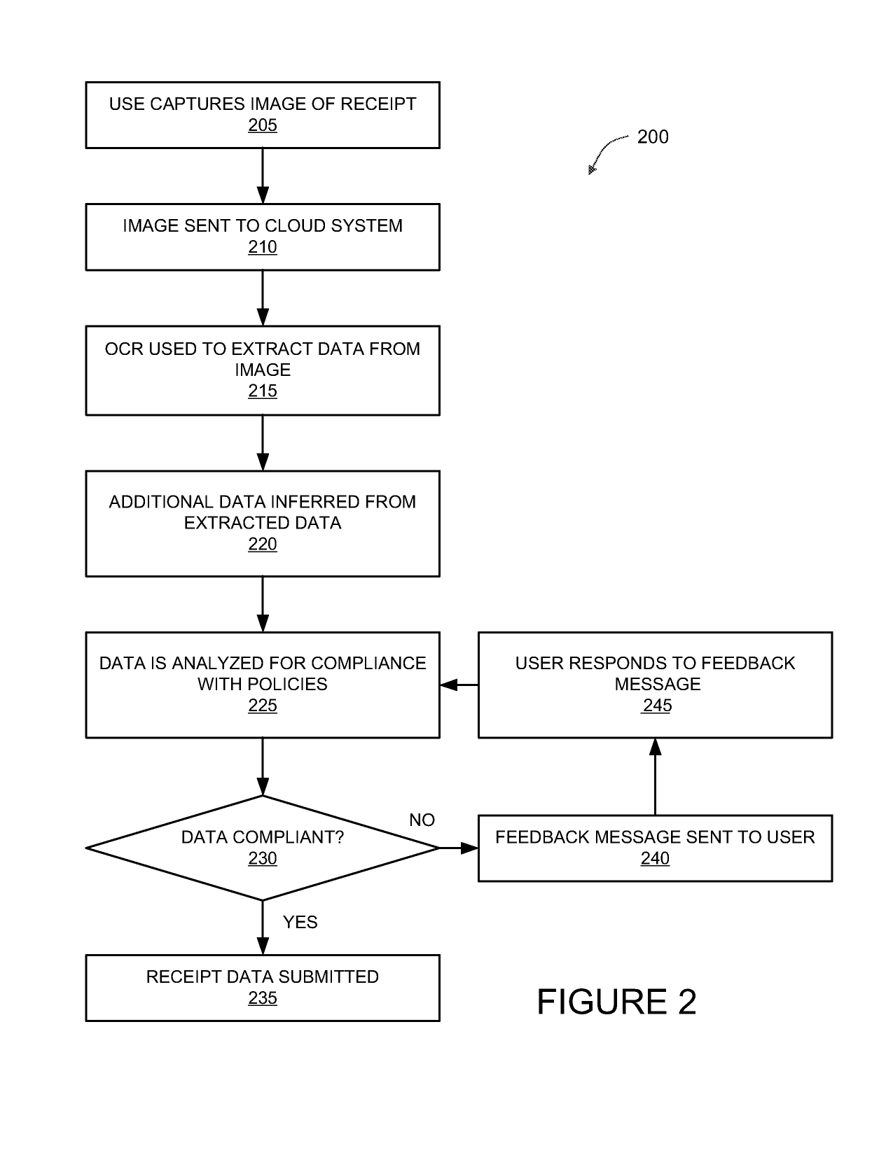

FIG. 2 illustrates a process 200 using artificial intelligence for real-time receipt verification and compliance notification using the system 100 (shown in FIG. 1), in accordance with at least one embodiment. The various steps of process 200 are performed by the devices of system 100.

In step 205, the user captures and image of a document 105 (shown in FIG. 1), such as a receipt by using capture device 110 (shown in FIG. 1). In at least one embodiment, the user captures 205 the image of the document 105 when the user receives the document 105, such as with the camera of their smartphone or other user computer device 115 (shown in FIG. 1). In at least one embodiment, the user captures 205 the receipt 105 in a mobile app on their user computer device 115. In another embodiment, the user uploads the receipt 105 to an expense form.

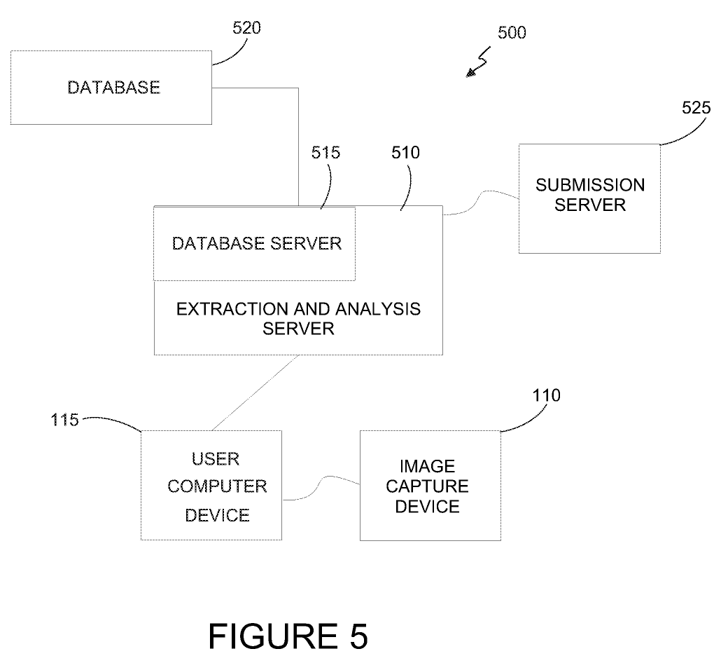

In step 210, the image is sent to a cloud system, such as the one hosting extraction computer device 120 and analysis computer device 125 (both shown in FIG. 1). In some embodiments, the extraction and analysis server 510 (shown in FIG. 5) hosts the extraction computer device 120 and analysis computer device 125.

In step 215, the extraction computer device 120 uses OCR (optical character recognition) and/or other techniques, such as natural language processing, to extract data from the image. This extraction returns extracted fields and document traits. These extracted document traits include, but are not limited to, amount, currency, date, vendor, category attributes, itemized flag, VAT/tax traits, and/or duplicate signals. In some embodiments, a classification artificial intelligence model is trained to classify the documents by document type. Examples of document types include, but are not limited to, dining receipt, fuel receipt, parking receipt, vehicle rental receipt, hotel receipt, and/or other expense receipts. In some further embodiments, the classification intelligence model is also trained to recognize invoices.

In step 220, the extraction computer device 120 and/or the analysis computer device 125 infers additional data from the extracted data. Examples of inferred data include, but are not limited to, number of people dining based on number of entrees ordered, number of nights stayed in hotel from check-in and check-out data, and location based on currency markers. In some embodiments, the inferred data is determined based on the document type. For example, a dining receipt will have different data than a hotel receipt or a vehicle rental receipt. In some embodiments, extraction computer device 120 and/or analysis computer device 125 fills out an expense form with the extracted and inferred data.

In step 225, the extracted data and the inferred data are analyzed to determine if they are in compliance with policies and/or regulations. In the example embodiment, the system 100 stores a plurality of trained artificial intelligence models including at least one trained model for each document type. The document type trained model has been trained to analyze the corresponding document type with its data to determine if the data for that document is compliant with policies and regulations. In these embodiments, different organizations may have different policies and rules. Accordingly, different AI models may be trained for the different organizations.

In step 230, the analysis computer device 125 determines if the data (extracted and inferred is compliant. In the example embodiment, this analysis 230 acts as a pre-submit check of the data based on the customer configuration and dynamic policy context. For example, the check may determine if all of the extracted and inferred data is correct for the policies of the corresponding organization. This analysis also compares the document and its data to previously submitted documents. For example, the document may be the second page of a multi-page hotel receipt. Then the analysis computer device 125 saves the data to be combined with later pages. The analysis computer device 125 also determines if a document is a duplicate, where the user already submitted that receipt to the system 100. In some embodiments, the system correlates multiple documents associated with a transaction context to perform cross-document semantic analysis, duplicate detection, document sequencing validation, and multi-document reconciliation.

If the data is compliant with the policies and regulations, the receipt data is submitted 235 to a submission system 135 (shown in FIG. 1). For example, the user may save and submit the document. The submission system 135 may require a post-submission review by an approver. The reviewer may further review the document and/or expense form. The reviewer’s feedback is then captured. This feedback may include, but is not limited to, thumb up/thumb down, reviewer actions, and any override rationale. Some of this feedback may be used for assurance analytics and policy insights. In some embodiments, reviewer override actions, remediation actions, approval outcomes, and user correction behavior are incorporated into retraining datasets to improve future compliance determinations and policy inference accuracy. If the expense is approved, then the expense is forwarded along the submission system 135.

If the data is not compliant with the policies and regulations, the analysis computer device 125 generates and sends 240 one or more feedback messages to the user, such as via their user computer device 115. The goal is to send this feedback before the user has had a chance to leave the location associated with the document, aka the restaurant that was associated with the receipt. In at least one embodiment, the feedback is provided as a push notification to the user computer device 115. The feedback provides pre-submit guidance and inline warnings. The push notification may be using any communication protocol the system 100 desires. These include, but are not limited to, SMS (Short Message Service), MMS (Multimedia Messaging Service), email, in app pop up, web push notification, and/or any other notification methodology desired.

In the example embodiment, the feedback is provided for data that is not compliant. For example, if the spend for each person at a dinner is too high, if the user double-tipped, if alcohol was charged when it was against policy, if the travel type is not covered, if the vehicle type is not covered, and/or any other clarification that may be needed before the receipt/expense may be submitted.

For feedback, the system 100 may highlight portions of the form or document to draw the user’s attention to correct that section. These may be fields in the form that the user needs to fill out prior to submission, such as purpose of the receipt, who was in attendance, and/or any other information that is needed for submission.

In step 245, the user responds to the feedback message. The user edits fields, adds business purposes, replaces the receipt, or adds justification. The user response and updated fields are then resubmitted to the analysis computer device 125, as shown in Step 225. This process 200 repeats until the data is considered compliant 230. In the example embodiment, the feedback message and the user response are both provided in real-time. This allows the user to respond to issues before walking away from the point of sale.

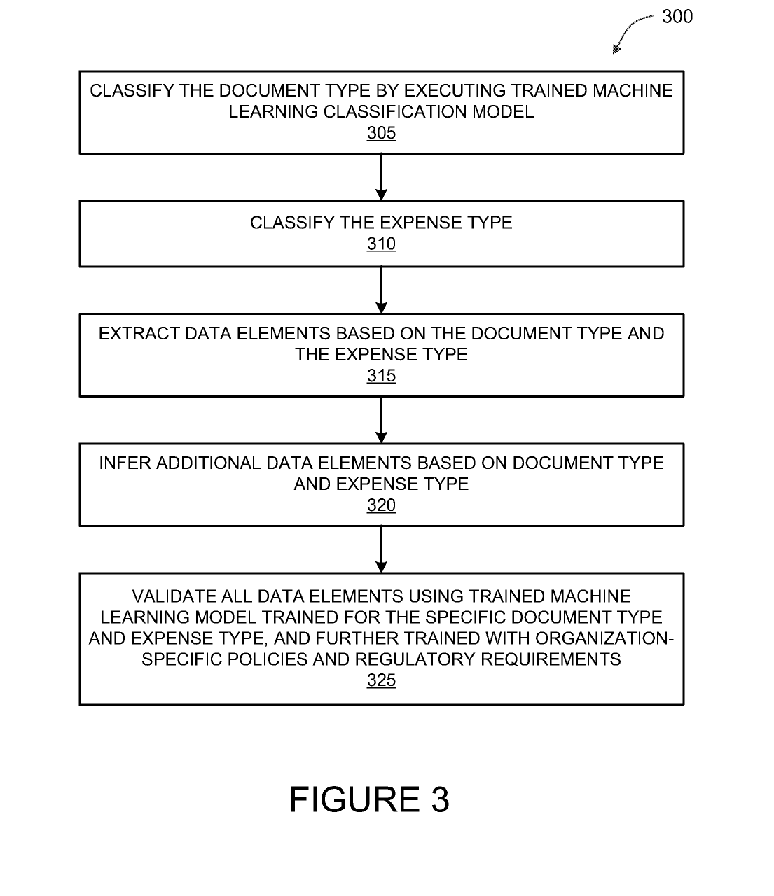

FIG. 3 illustrates an exemplary process 300 for using artificial intelligence for real-time receipt verification and compliance notification using the system 100 (shown in FIG. 1), in accordance with at least one embodiment. In the example embodiment, the steps of process 300 are performed by the extraction and analysis server 510 (shown in FIG. 1). In the example embodiment, the extraction and analysis server 510 stores a plurality of trained artificial intelligence models. Some of these models are classification models that are trained to identify different document types from images and data. The data may include document attributes that allow the classification model to determine the type of the document and the corresponding expense. Other models are trained to determine context from the document 105 (shown in FIG. 1) and the corresponding data. In many embodiments, these models are trained for a specific document type and the rules associated for that document type from a specific organization and any regulatory requirements. For example, there may be trained model for hotel receipts for organization A and a different trained model for hotel receipts for organization B. In other embodiments, the model for hotel receipts may be trained for multiple organizations and the organization that the hotel receipt is analyzed under is set by a flag provided to the trained model.

In step 305, the extraction and analysis server 510 classifies the document type by executing a trained machine learning classification model. The machine learning classification model uses document attributes and data found in the document 105 to determine the document type.

In step 310, the extraction and analysis server 510 classifies the expense type based on the document type. For example, the expense may be considered a meal based on the document 105 being a restaurant receipt. The expense may also be a materials expense if the document 105 is an invoice from a lumberyard.

In step 315, the extraction and analysis server 510 extracts data elements from the document 105 based on the document type and expense type. The document type and the expense type guide the extraction and analysis server 510 in determining which data fields are important and/or necessary. This also assists the extraction and analysis server 510 in preparing one or more submission forms.

In step 320, the extraction and analysis server 510 infers additional data elements based on the document type and the expense type. These inferred data elements may be needed data but not provided on the face of the document 105. In some embodiments, the document 105 is combined with other previously submitted documents 105. In these embodiments, the inferred data is based on analysis of the provided documents 105.

In step 325, the extraction and analysis server 510 routes the extracted and inferred data to a trained machine learning model trained for the specific document type and expense type and further trained with the organization specific policies and regulatory requirements. In some further embodiments, there are multiple models available for an expense type and organization based on jurisdiction, especially for multinational organizations. The extraction and analysis server 510 validates all of the data elements using the trained machine learning model. In some embodiments, the extraction and analysis server 510 includes a dynamic routing engine configured to select a specialized validation pipeline based on one or more of: inferred document type, expense category, merchant classification, transaction metadata, geographic jurisdiction, organization-specific policy context, and semantic confidence scores.

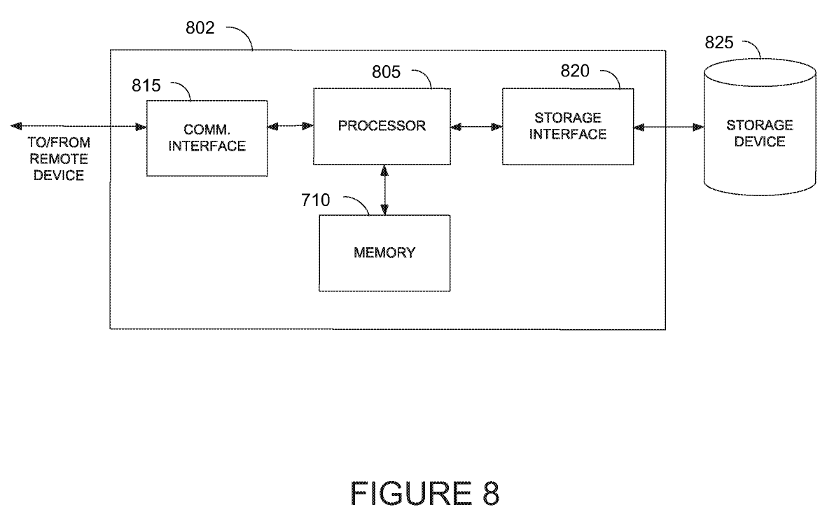

In the exemplary embodiment, a system 100 for real-time receipt verification and compliance notification includes a computer device, such as the extraction and analysis server 510 (shown in FIG. 5). The computer device 510 includes at least one processor 805 in communication with at least one memory device 810 (both shown in FIG. 8).

In the exemplary embodiment, the extraction and analysis server 510 receives 210 an image of a document 105 to be analyzed.

In the exemplary embodiment, the extraction and analysis server 510 extracts 215 a plurality of data from the image of the document 105.

In the exemplary embodiment, the extraction and analysis server 510 executes 305 a classification model trained to identify a document type based on the plurality of data. The classification model outputs a document type for the document 105. The document 105 is a receipt and the document type is a receipt type, such as, but not limited to, dining receipt, fuel receipt, parking receipt, vehicle rental receipt, hotel receipt, and/or other expense receipts.

In the exemplary embodiment, the extraction and analysis server 510 determines an analysis model of a plurality of analysis models to execute based on the document type. The extraction and analysis server 510 dynamically routes the document 105 to a specialized validation pipeline based on at least one of inferred document type, expense category, jurisdiction, merchant classification, and organization-specific policy context.

In the exemplary embodiment, the extraction and analysis server 510 executes 325 the determined analysis model for the document type. The analysis model has been trained to validate the plurality of data from the document 105 in view of a plurality of policies. The determined analysis model is trained with a plurality of policies for an organization. The plurality of policies are for reimbursement of an expense.

In the exemplary embodiment, the extraction and analysis server 510 detects 230 a compliance issue with the document 105 based on the execution of the determined analysis model. The compliance issue is non-compliance with one or more policies of the plurality of policies. The compliance issue is a failed check for at least one of an itemized receipt, a valid tax receipt, and a tip amount anomaly.

In the exemplary embodiment, the extraction and analysis server 510 provides 240 real-time feedback on the document 105 based on the detected compliance issue with the document 105. The real-time feedback provides suggestions for overcoming the compliance issue with the document 105. Furthermore, as described herein, real-time feedback is generated within a transaction-bound remediation interval before termination of an associated transaction session or departure from a transaction location. The extraction and analysis server 510 receives updated information from the user in response to the detected compliance issue. Then the extraction and analysis server 510 revalidates the document 105 based on the updated information. In the exemplary embodiment, the extraction and analysis server 510 repeats the cycle of analysis 225 and feedback 240 until no issues are detected.

In some further embodiments, the extraction and analysis server 510 classifies an expense type based on the document type.

In some further embodiments, when no compliance issue is detected, the extraction and analysis server 510 submits the document 105 for reimbursement. The extraction and analysis server 510 performs additional compliance checks prior to submitting the document 105 for reimbursement. These additional compliance checks include at least one of a duplicate receipt check and a personal expense check.

In some further embodiments, the extraction and analysis server 510 analyzes the document 105 in view of one or more previously submitted documents. In some embodiments, the extraction and analysis server 510 aggregates extracted data across multiple transaction-related documents. In further embodiments, the extraction and analysis server 510 correlates the document 105 with one or more previously submitted documents 105 associated with a transaction context.

In some further embodiments, the image of the document 105 is submitted from a user computer device 115, where the image was captured 110 by a camera of the user computer device 115. The real-time feedback is submitted as a push notification to the user computer device 115 that the image was received from.

In some further embodiments, the extraction and analysis server 510 infers one or more items of data from the plurality of data and the document type. The extraction and analysis server 510 performs one or more additional compliance checks based on the one or more inferred items of data.

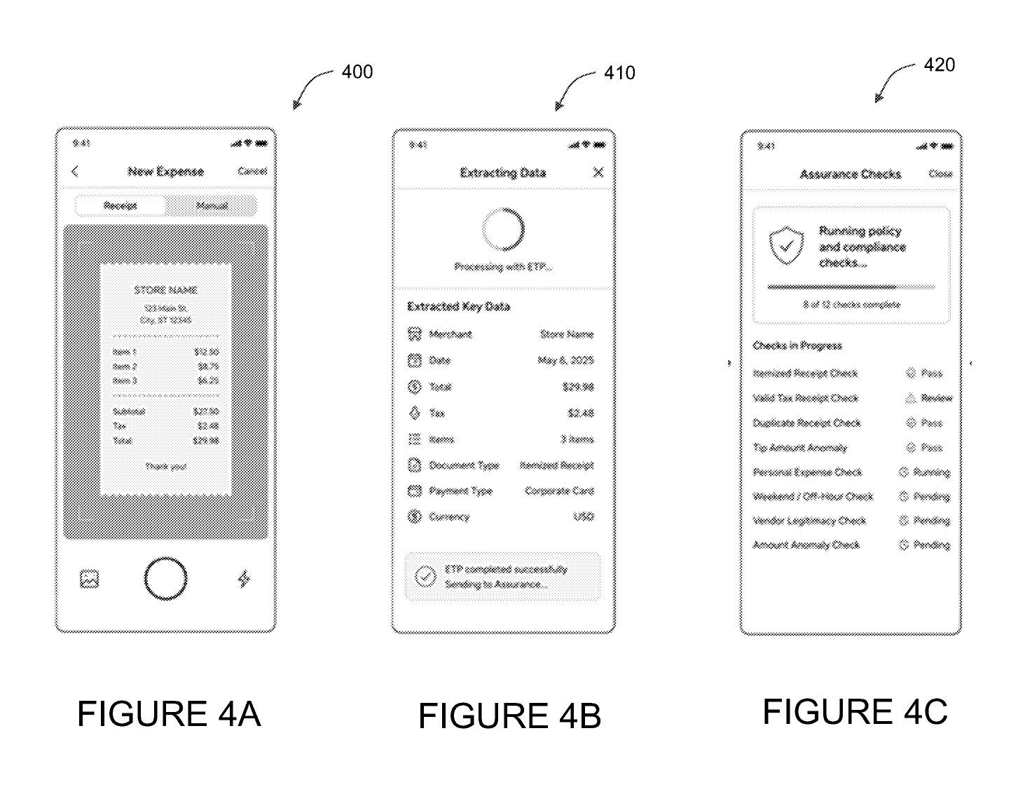

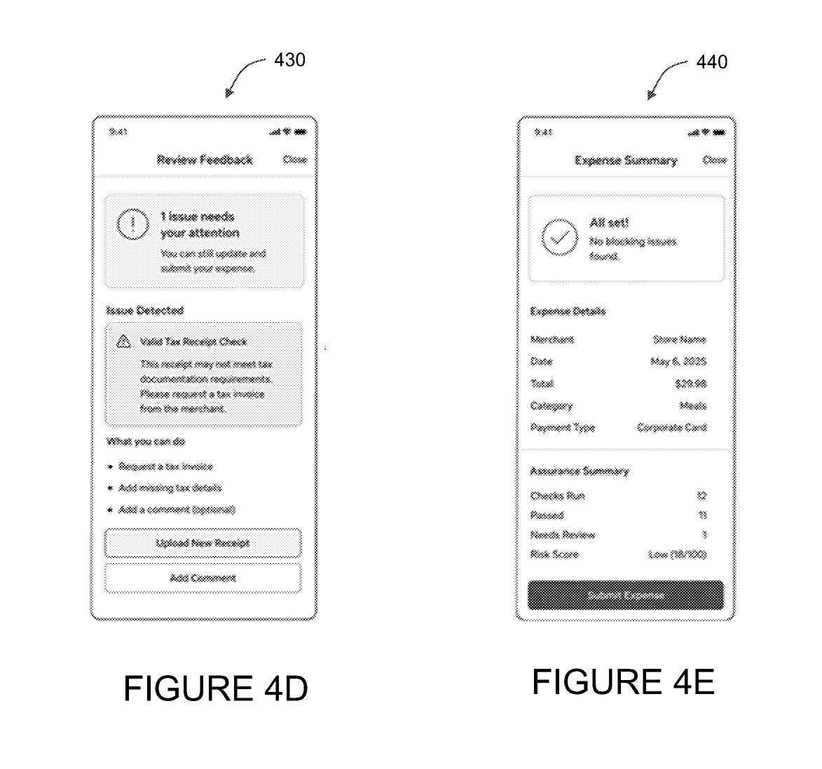

FIGS. 4A-4E illustrate views of a user interface 400 for real-time receipt verification and compliance notification using the system 100 (shown in FIG. 1). FIG. 4A illustrates the user interface 400 when the user captures 205 (shown in FIG. 2) an image of their receipt 105 (shown in FIG. 1). FIG. 4B illustrates the user interface 410 as the extraction computer device 120 (shown in FIG. 1) is extracting 215 (shown in FIG. 2) data (data fields and document attributes) from the image of the receipt 105. User interface 410 illustrates example data fields, including merchant, date, total, items, document type, payment type, and currency. FIG. 4C illustrates the user interface 420 when the analysis computer device 125 (shown in FIG. 1). The analysis computer device 125 runs multiple checks using the extracted data and organization policies. Examples of checks shown in user interface 420 include itemized receipt check, valid tax receipt check, duplicate receipt check, tip anomaly check, personal expense check, weekend/off-hour check, vendor legitimacy check, and account anomaly check.

The multiple artificial intelligence model system 100 described herein provides a significant improvement over other methodologies. By having multiple AI models each trained for different document types, this significantly reduces the amount of computing resources required for training and execution of these models. Furthermore, using a first model to identify the document type, allows for the efficient use of these models to allow them to work in real-time. In contrast to having a single large model that handles multiple document types, this requires significantly more computing resources to train, store, and execute. This separated system allows for efficient and streamlined use of these AI models. Furthermore, having models trained for specific document types prevents the chance of AI confusion and hallucinations, greatly increasing the accuracy of the output of these models.

FIG. 4D illustrates a user interface 430 showing feedback, such as provided in step 240 (shown in FIG. 2). The user interface shows that issues need the user’s attention and provides guidance including potential steps that the user may take to mitigate this issue before submitting the receipt 105. The feedback allows the user to respond 245 (shown in FIG. 2) in real-time. FIG. 4E illustrates a user interface 440 showing once the user has responded 245 and all issues are resolved, and the receipt 105 has been submitted 235 (FIG. 2) to the submission system 135 (shown in FIG. 1). User interface 440 provides a dashboard showing where the receipt 105 is in the review process.

FIG. 5 illustrates an exemplary computer system for real-time receipt verification and compliance notification, in accordance with at least one embodiment of the disclosure. In the exemplary embodiment, the system 500 provides executing trained artificial intelligence models to categorize, analyze, and validate documents 105 (shown in FIG. 1), including receipts and expenses.

As described below in more detail, the extraction and analysis server 510 may be programmed to analyze and validate receipts 105. In some embodiments, the extraction and analysis server 510 may be programmed to: a) receive 210 an image of a document 105 to be analyzed; b) extract 215 a plurality of data from the image of the document 105; c) execute 305 a classification model trained to identify a document type based on the plurality of data, where the classification model outputs a document type for the document; d) determine an analysis model of a plurality of analysis models to execute based on the document type; e) execute 325 the determined analysis model for the document type, wherein the analysis model has been trained to validate the plurality of data from the document 105 in view of a plurality of policies; f) detect a compliance issue with the document based on the execution of the determined analysis model; and g) provide 240 real-time feedback on the document 105 based on the detected compliance issue with the document 105.

In the example embodiment, user computer devices 115 are computers that include a web browser or a software application, which enables user computer devices 115 to communicate with extraction and analysis server 510 using the Internet, a local area network (LAN), or a wide area network (WAN). In some embodiments, the user computer devices 115 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 115 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, LLMs (Large Language Models) or any other transformer based, or otherwise, Artificial Intelligence system, or other web-based connectable equipment or mobile devices.

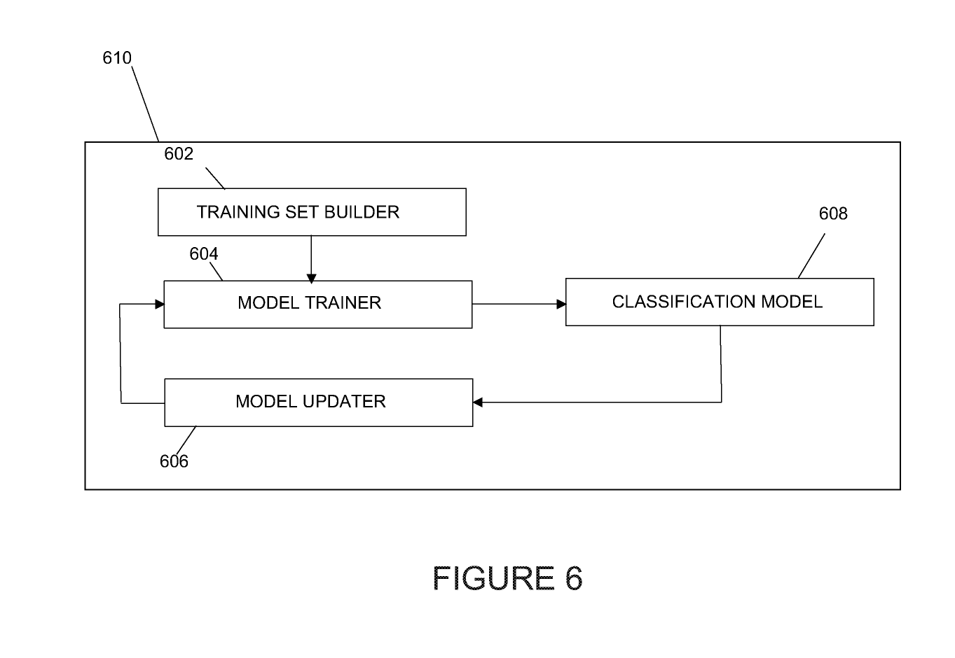

In the example embodiment, the extraction and analysis server 510 is a computer that includes a web browser or a software application, which enables extraction and analysis server 510 to communicate with user computer devices 115, submission servers 525, and other devices through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. Furthermore, the extraction and analysis server 510 may include an artificial intelligence (AI)/deep learning module 610 (as shown in FIG. 6) for training and/or updating a classification AI model or a document analysis and verification AI model. In some embodiments, the extraction and analysis server 510 may be implemented as a server computing device with artificial intelligence and deep learning functionality. In some embodiments, the extraction and analysis server 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The extraction and analysis server 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, LLMs (Large Language Models) or any other transformer based, or otherwise, Artificial Intelligence system, or other web-based connectable equipment or mobile devices.

A database server 515 is communicatively coupled to a database 520 that stores data. In one embodiment, the database 520 is a database that includes receipt information, document attributes, extracted data, inferred data, policies, and/or regulations. In some embodiments, the database 520 is stored remotely from the extraction and analysis server 510. In some embodiments, the database 520 is decentralized. In the example embodiment, a person can access the database 520 via the user computer devices 115 by logging onto the extraction and analysis server 510.

The submission server 525 may be any computer device or network device that is configured to receive and transmit network traffic. In the example embodiment, submission servers 525 are associated with submission systems 135. In the example embodiment, submission servers 525 are computers that include a web browser or a software application, which enables submission servers 525 to communicate with the extraction and analysis server 510 using the Internet, a local area network (LAN), or a wide area network (WAN). In some embodiments, the submission servers 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Submission servers 235 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, LLMs (Large Language Models) or any other transformer based, or otherwise, Artificial Intelligence system, network devices, or other web-based connectable equipment or mobile devices.

FIG. 6 depicts an artificial intelligence (AI)/deep learning (DL) module 610, according to an embodiment. In some embodiments, AI/DL module 610 includes a training set builder module 602 programmed to submit one or more queries to database 520 (shown in FIG. 5) to retrieve data and/or subsets of data, and to use those subsets to build training data sets for generating predictive, classification, and/or analysis models.

In example embodiments, training set builder module 602 is programmed to retrieve training data sets from the retrieved subsets. Each training data set corresponds to document data, such as extracted text, structured data fields, and document attributes derived from receipt and expense document images. “Historical” in this context may be defined as previously determined risk, as opposed to risk assessment completed in real-time with respect to the time of retrieval by training set builder module 602. Each training data set includes “model input” data fields along with at least one “result” data field, such as shown in FIG. 1. The model input data fields represent factors that may be expected to, or unexpectedly be found during model training to have some correlation with other fields and/or messages.

After training set builder module 602 generates training data sets, training set builder module 602 passes the training data sets to model trainer module 604. In some embodiments, model trainer module 604 is programmed to apply the model input data fields of each training data set as inputs to one or more machine learning models. Each of the one or more machine learning models is programmed to produce, for each training data set, at least one output intended to correspond to, or “predict,” or “classify” a value of the at least one result data field of the training data set. “Machine learning” refers broadly to various algorithms that may be used to train the model to identify and recognize patterns in existing data in order to facilitate making predictions for subsequent new input data.

Model trainer module 604 is programmed to compare, for each training data set, the at least one output of the model to the at least one result data field of the training data set and apply a machine learning algorithm to adjust parameters of the model in order to reduce the difference or “error” between the at least one output and the corresponding at least one result data field. In this way, model trainer module 604 trains the machine learning model to accurately classify document types. In other words, model trainer module 604 cycles the one or more machine learning models through the training data sets, causing adjustments in the model parameters, until the error falls below a suitable threshold, and then uploads at least one trained machine learning model to classification model module 608 for application to different documents 105 (shown in FIG. 1) for different document types.

In some embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer. As model trainer module 604 cycles through the training data sets, model trainer module 604 applies a suitable backpropagation algorithm to adjust the weights in each node layer to minimize the error between the at least one output and the corresponding result data field. In this fashion, the machine learning model is trained to produce one or more outputs which reliably classify document types and identify policy compliance issues based on the extracted and inferred document data. Alternatively, the machine learning model has any suitable structure. In some embodiments, model trainer module 604 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

Additionally, or alternatively, the one or more machine learning models may include one or more multilayer perceptron (MLP) classifiers. A MLP classifier may comprise input and output layers, and one or more hidden layers with many neurons stacked together.

Additionally, or alternatively, the one or more machine learning models may include one or more support vector machines (SVMs). SVMs are supervised learning models with associated learning algorithms that analyze data for classification and regression analysis. More particularly, a SVM constructs a hyperplane or set of hyperplanes in a high or infinite-dimensional space, which can be used for classification, regression, or other tasks like outliers detection.

In some embodiments, classification model module 608 compares the classification confidence for the classification of a document with the output from the trained model, and routes the comparison result to a model updater module 606 of AI/DL module 610. Model update module 610 is programmed to derive a correction signal from the comparison results, and to provide correction signal to model trainer module 604 to enable updating or “re-training” of the at least one machine learning model to improve performance. The retrained machine learning model may be periodically re-uploaded to classification model module 608.

In some embodiments, model trainer module 604 may update the training dataset by creating one or more new historical records which include new data and re-training the operator model using the updated training dataset, further improving the accuracy of the operator model.

In some embodiments, the user computer device 115 (shown in FIG. 1) and/or the extraction and analysis server 510 (shown in FIG. 5) includes an application module that is configured to facilitate maintaining a data management application and providing the functionality thereof to users. The application module may store instructions that enable the download and/or execution of data management application at user computer devices 115. The application module may store instructions regarding user interfaces, controls, commands, settings, and the like, and may format data into a format suitable for transmitting to user computer devices 115 for display thereof.

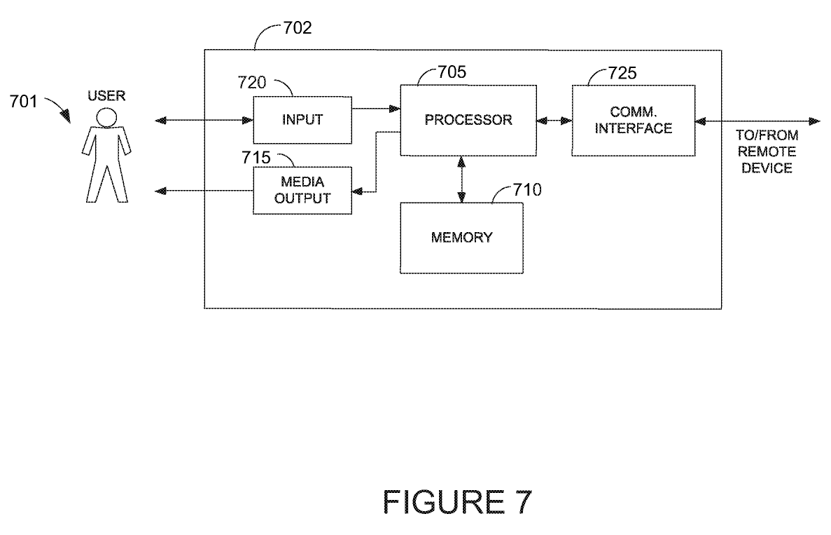

FIG. 7 depicts an exemplary configuration of user computer device 702, in accordance with one embodiment of the present disclosure. In the exemplary embodiment, user computer device 702 may be similar to, or the same as, capture device 110 and user computer device 115 (both shown in FIG. 1). User computer device 702 may be operated by a user 701.

User computer device 702 may include a processor 705 for executing instructions. In some embodiments, executable instructions may be stored in a memory area 710. Processor 705 may include one or more processing units (e.g., in a multi-core configuration). Memory area 710 may be any device allowing information such as executable instructions and/or transaction data to be stored and retrieved. Memory area 710 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 705 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 715 may be configured to present a graphical user interface (e.g., a web browser and/or a client application) to user 701. A graphical user interface may include, for example, an interface for viewing items of information provided by the extraction and analysis server 510 (shown in FIG. 5). In some embodiments, user computer device 702 may include an input device 720 for receiving input from user 701. User 701 may use input device 720 to, without limitation, provide information either through speech or typing.

Input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

User computer device 702 may also include a communication interface 725, communicatively coupled to a remote device such as the extraction and analysis server 510. Communication interface 725 may include, for example, a wired or wireless network adapter and/or a wireless data transceiver for use with a mobile telecommunications network.

Stored in memory area 710 are, for example, computer readable instructions for providing a user interface to user 701 via media output component 715 and, optionally, receiving and processing input from input device 720. A user interface may include, among other possibilities, a web browser and/or a client application. Web browsers enable users, such as user 701, to display and interact with media and other information typically embedded on a web page or a website from the extraction and analysis server 510. A client application may allow user 701 to interact with, for example, the extraction and analysis server 510. For example, instructions may be stored by a cloud service, and the output of the execution of the instructions sent to the media output component 715.

FIG. 8 depicts an exemplary configuration of a server computer device 801, in accordance with one embodiment of the present disclosure. In the exemplary embodiment, server computer device 801 may be similar to, or the same as, extraction computer device 120, analysis computer device 125 (both shown in FIG. 1), extraction and analysis server 510, database server 515, and submission server 525 (all shown in FIG. 5). Server computer device 801 may also include a processor 805 for executing instructions. Instructions may be stored in a memory area 810. Processor 805 may include one or more processing units (e.g., in a multi-core configuration).

Processor 805 may be operatively coupled to a communication interface 815 such that server computer device 801 is capable of communicating with a remote device such as another server computer device 801, extraction and analysis server 510, submission server 525, and user computer devices 115 (shown in FIG. 1) (for example, using wireless communication or data transmission over one or more radio links or digital communication channels). For example, communication interface 815 may receive input from user computer devices 115 via the Internet, as illustrated in FIG. 5.

Processor 805 may also be operatively coupled to a storage device 825. Storage device 825 may be any computer-operated hardware suitable for storing and/or retrieving data, such as, but not limited to, data associated with one or more models. In some embodiments, storage device 825 may be integrated into server computer device 801. For example, server computer device 801 may include one or more hard disk drives as storage device 825.

In other embodiments, storage device 825 may be external to server computer device 801 and may be accessed by a plurality of server computer devices 801. For example, storage device 825 may include a storage area network (SAN), a network attached storage (NAS) system, and/or multiple storage units such as hard disks and/or solid-state disks in a redundant array of inexpensive disks (RAID) configuration.

In some embodiments, processor 805 may be operatively coupled to storage device 825 via a storage interface 820. Storage interface 820 may be any component capable of providing processor 805 with access to storage device 825. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 805 with access to storage device 825.

Processor 805 may execute computer-executable instructions for implementing aspects of the disclosure. In some embodiments, the processor 805 may be transformed into a special purpose microprocessor by executing computer-executable instructions or by otherwise being programmed. For example, the processor 805 may be programmed with the instructions such as illustrated in FIGS. 2 and 3.

### MACHINE LEARNING AND OTHER MATTERS

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the extraction and analysis server 510 is configured to implement machine learning, such that the extraction and analysis server 510 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data (i.e., multi-modal type of data). ML outputs may include, but are not limited to identified objects, items classifications, textual product, and/or other data extracted from the images or textual data. In some embodiments, data inputs may include certain ML outputs (i.e., overall convergence optimization parameters or multiple localized convergence points that lack an optimal convergence point).

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, labeled samples of receipt and expense documents representing a plurality of document types, expense categories, and merchant types, along with corresponding compliance determinations.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, an ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a LLMs (Large Language Models) or any other transformer based, or otherwise, Artificial Intelligence system chatbot. The voice or chatbot may employ supervised or unsupervised machine learning techniques, which may be followed by, and/or used in conjunction with, reinforced or reinforcement learning techniques. The voice or chatbot may employ the techniques utilized for LLMs. The voice bot, chatbot, LLMs (Large Language Models) or any other transformer based, or otherwise, Artificial Intelligence system, and/or other bots may generate audible or verbal output, text or textual output, visual or graphical output, output for use with speakers and/or display screens, and/or other types of output for user and/or other computer or bot consumption.

Based upon these analyses, the processing element may learn how to classify documents and analyze expenses. The processing element may also learn how to identify or detect documents based on the document attributes and/or analyze expenses and other information extracted from and inferred from the documents.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a reduced instruction set circuit (RISC), an application specific integrated circuit (ASIC), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are for example only, and thus are not intended to limit in any way the definition and/or meaning of the term database. Examples of RDBMS’ include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously. Furthermore, as described herein, real-time feedback is generated within a transaction-bound remediation interval before termination of an associated transaction session or departure from a transaction location.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independently and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising at least one computer device comprising at least one processor in communication with at least one memory device, wherein the at least one processor is programmed to:
receive an image of a document to be analyzed;
extract a plurality of data from the image of the document;
execute a classification model trained to identify a document type based on the plurality of data, where the classification model outputs a document type for the document;
determine an analysis model of a plurality of analysis models to execute based on the document type;
execute the determined analysis model for the document type, wherein the analysis model has been trained to validate the plurality of data from the document in view of a plurality of policies;
detect a compliance issue with the document based on the execution of the determined analysis model; and
provide real-time feedback on the document based on the detected compliance issue with the document.

2. The system of claim 1, wherein the real-time feedback provides suggestions for overcoming the compliance issue with the document.

3. The system of claim 1, wherein the at least one processor is further programmed to:
receive updated information from a user in response to the detected compliance issue; and
revalidate the document based on the updated information.

4. The system of claim 1, wherein the at least one processor is further programmed to repeat a cycle of analysis and feedback until no issues are detected.

5. The system of claim 1, wherein the at least one processor is further programmed to classify an expense type based on the document type.

6. The system of claim 1, wherein the determined analysis model is trained with a plurality of policies for an organization.

7. The system of claim 1, wherein the compliance issue is non-compliance with one or more policies of the plurality of policies.

8. The system of claim 5, wherein the compliance issue is a failed check for at least one of an itemized receipt, a valid tax receipt, and a tip amount anomaly.

9. The system of claim 1, wherein the document is a receipt, wherein the document type is a receipt type, and wherein the plurality of policies are for reimbursement of an expense.

10. The system of claim 1, wherein when no compliance issue is detected, the at least one processor is programmed to submit the document for reimbursement.

11. The system of claim 10, wherein the at least one processor is further programmed to perform additional compliance checks prior to submitting the document for reimbursement, wherein the additional compliance checks include at least one of a duplicate receipt check and a personal expense check.

12. The system of claim 1, wherein the at least one processor is further programmed to aggregate extracted data across multiple transaction-related documents.

13. The system of claim 1, wherein to validate the document the at least one processor is further programmed to correlate the document with one or more previously submitted documents associated with a transaction context.

14. The system of claim 1, wherein the image of the document is submitted from a user computer device, wherein the image was captured by a camera of the user computer device.

15. The system of claim 1, wherein the real-time feedback is submitted as a push notification to a user computer device that the image was received from.

16. The system of claim 1, wherein the at least one processor is further programmed to infer one or more items of data from the plurality of data and the document type.

17. The system of claim 16, wherein the at least one processor is further programmed to perform one or more additional compliance checks based on the one or more inferred items of data.

18. The system of claim 1, wherein to determine the analysis model the at least one processor is further programmed to dynamically route the document to a specialized validation pipeline based on at least one of inferred document type, expense category, jurisdiction, merchant classification, and organization-specific policy context.

19. A computer-implemented method is implemented using at least one processor in communication with at least one memory device, wherein the method comprises:
receiving an image of a document to be analyzed;
extracting a plurality of data from the image of the document;
executing a classification model trained to identify a document type based on the plurality of data, where the classification model outputs a document type for the document;
determining an analysis model of a plurality of analysis models to execute based on the document type;
executing the determined analysis model for the document type, wherein the analysis model has been trained to validate the plurality of data from the document in view of a plurality of policies;
detecting a compliance issue with the document based on the execution of the determined analysis model; and
providing real-time feedback on the document based on the detected compliance issue with the document.

20. The computer-implemented method of claim 19, wherein the real-time feedback provides suggestions for overcoming the compliance issue with the document, the method further comprising:
receiving updated information from a user in response to the detected compliance issue; and
revalidating the document based on the updated information.
